(19) United States
(12) Patent Application Publication
(10) Pub. No.: US 2025/0044205 A1
(43) Pub. Date: Feb. 6, 2025

(54) APPARATUSES, SYSTEMS, AND METHODS TO MEASURE DESICCANT CONCENTRATION IN AIR CONDITIONING SYSTEMS

(71) Applicant: AirGreen, Inc., New Castle, DE (US)

(72) Inventor: John Hammond, New Castle, DE (US)

(21) Appl. No.: 18/791,138

(22) Filed: Jul. 31, 2024

Related U.S. Application Data
(60) Provisional application No. 63/517,299, filed on Aug. 2, 2023.

(51) Int. Cl. G01N 9/04; F24F 5/00; G01F 23/296

(52) U.S. Cl. CPC G01N 9/04; F24F 5/0014; G01F 23/296

(57) ABSTRACT

A concentration processor for a liquid desiccant air conditioning system (LDAC). The LDAC has a level tank with a level sensor fluidly coupled to the basin (or basins) of the LDAC to provide a height of the liquid desiccant. A pressure sensor fluidly coupled to the basin (or basins) of the LDAC to provide a mass or weight of the liquid desiccant. Optionally, a temperature sensor fluidly coupled to the basin (or basins) to provide the temperature of the desiccant solution. The concentration processor uses the known geometry of the basin (or basins) to calculate the density or concentration of the liquid desiccant. The concentration of the liquid desiccant is determinable in real time and as a result may be used to automatically adjust and/or maintain the concentration to a desired level in order to optimize overall system performance, store concentrated desiccant as a means to store energy, and to operate the overall systems in a way that minimizes energy use.

### CROSS-REFERENCE TO RELATED PATENT APPLICATIONS

The present application claims priority to U.S. Provisional Patent Application 63/517,299, titled Apparatuses, Systems, and Methods to Measure Desiccant Concentration in Air Conditioning Systems, filed Aug. 2, 2024, the disclosure of which is incorporated herein by reference as if set out in full for all purposes.

The present application is related to U.S. Pat. No. 9,982,901, titled Air Conditioning Method using a Staged Process using a Liquid Desiccant, which issued May 29, 2018, and U.S. Pat. No. 10,823,436, titled the same, which issued Nov. 3, 2020, the disclosures of with are incorporated herein by reference as if set out in full for all purposes.

### BACKGROUND

The technology of the present application relates to air conditioning, refrigeration, and dehumidification systems (and systems that simultaneously cool and dehumidify) and apparatuses, systems, and methods that can measure liquid desiccant concentration in the air conditioning systems that cool and de-humidify air.

Desiccant interacting with an air stream can cool and de-humidify air as explained in both U.S. Pat. Nos. 9,982,901 and 10,823,436. As explained in these patents, desiccant based systems have been known for a long time. Prior to these patents, however, desiccant based systems were not cost effective as the energy savings of the desiccant based systems were not sufficient to overcome the high capital investment.

U.S. Pat. Nos. 9,982,901 and 10,823,436 describe a desiccant air conditioning system that has a device 1 that cools and de-humidifies an air stream using desiccant. The desiccant is diluted in the device 1. As the desiccant is diluted, the efficacy of the air conditioning system using the desiccant decreases. Thus, U.S. Pat. Nos. 9,982,901 and 10,823,436 also provide a device 2 that is a desiccant regenerator. The diluted desiccant is concentrated in the device 2 and eventually recirculated back to device 1. However, the actual concentration of the liquid desiccant in either device 1 or in device 2 at any single time is unknown, and is often different depending on the ambient temperature or humidity load on the overall system.

Desiccant solutions, or brine solutions, are commonly used in vapor absorption refrigeration systems, or absorption chillers, where water is the refrigerant and the desiccant solution is used as the absorbent. Although this is truly a closed system, the concentration of the desiccant solution must be monitored to ensure performance as air leaks can cause irrecoverable dilution of the desiccant solution. The concentration can be determined by a tedious and time-consuming chemical analysis and method of titration requiring skilled personnel, a measurement of electrolytic conductivity that is equally tedious and time consuming, or radioactive tracer detection, which is a highly expensive undertaking. In these cases, such precise measurements required skilled personnel, and such uniquely skilled personnel are often not the same personnel charged with operating and maintaining such equipment. An off-line measurement of specific gravity of the solution, adjusted for temperature, is a typical method for quickly determining a close approximation of the desiccant concentration, provided no other contaminants are contained in that solution. Thus, a simple, continuous, and direct measurement technique not requiring unique skills is desirable.

Unlike vapor absorption refrigeration systems, liquid desiccant air conditioning systems similar to and including those covered in U.S. Pat. Nos. 9,982,901 and 10,823,436, rely upon direct contact between the airstream that is to be cooled and dehumidified, or in the case of membrane systems, direct absorption of water vapor from the airstream adjacent to the desiccant solution. As such, these systems are not truly closed systems and the concentration of the desiccant solution has the potential to vary more widely. If the solution becomes too dilute, the system performance degrades, and if the solution becomes too concentrated, crystallization of the desiccant salts can occur, potentially causing blockages.

In applications at atmospheric air pressure conditions where the desired conditioned air temperatures and dew point are below freezing (<32° F. or <0° C.)), the desirable desiccant concentration can be close to the freezing point of the solution and thus maintenance of the desired desiccant concentration is necessary to avoid freezing while maintaining optimum performance.

Eventually, even in some embodiments with regenerative capabilities, the desiccant is overly diluted and the efficiency of the air conditioning system decreases. Or, in some instances, the system generates high concentrations of liquid desiccant, which presents the problem of desiccant crystallization which hampers performance. While the concentration of the liquid desiccant is actually unknown, operators of these air conditioning systems subsequently add desiccant, typically of a known concentration, to the system to increase the overall desiccant concentration or add fluid, such as water, to dilute the concentration. Alternatively, operators of such air conditioning systems may adjust the balance between the rates of dehumidification and the desiccant fluid regeneration (or concentration) to achieve the desired overall desiccant concentration that provides satisfactory performance. However, as the temperature and moisture content (humidity) of the airstream to be conditioned continuously change hour to hour and certainly day to night, such balance is difficult to achieve by manual adjustment. And, as the actual concentration of the liquid desiccant is unknown, the steps the operator takes may not be effective and, in some cases, may exasperate any operating issues.

However, despite being an important factor in the operation of a desiccant based air conditioning system, present air conditioning systems do not effectively measure, or generally attempt to measure, the concentration of the desiccant, leading to suboptimal performance. At best, many such systems just typically measure the overall desiccant solution levels, or volume, of the system and attempt to infer whether the overall solution is becoming dilute because the total volume of desiccant solution is increasing, or oppositely, becoming more concentrated as the total volume decreases. There are problems with conventional methods, however. For example, the desiccant basins, or sumps, are volatile and turbulent making any level measurements approximations at best. Additionally, any system leaks will falsely indicate increases in concentration.

Thus, against this background, it would be desirable to provide apparatuses, systems, and methods to measure and report desiccant concentrations in real time (or near real time) in air conditioning systems.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, a system to determine the concentration of liquid desiccant in a liquid desiccant air conditioning system is provided. The system has a separate level tank located outside of the primary basin having a top connection and bottom connection configured to be in fluid communication with a basin of the liquid desiccant air conditioning (LDAC) system such that the level tank can contain liquid desiccant, wherein the level tank has a length, width, and height and the liquid desiccant contained in the level tank has a top such that the height of the liquid desiccant in the level tank is equal to the height of the liquid desiccant in the basin. A level sensor operationally coupled to the level tank is utilized to determine the height of the liquid desiccant contained in the level tank, which is more or less equivalent to the level in the basin, but separated to allow for the avoidance of turbulence and to allow for access and maintenance. A pressure sensor operationally coupled to the basin of the LDAC to determine the mass of the liquid desiccant contained in the basin, wherein the basin has a known geometry. A concentration processor operationally coupled to the level sensor and the pressure sensor wherein the concentration processor calculates a concentration of the liquid desiccant in the basin based on the height of the liquid desiccant and the mass of the liquid desiccant, wherein the concentration processor outputs the concentration of the liquid desiccant in the basin.

In certain embodiments, the system comprises an ultrasonic level sensor, a pressure sensor comprising a pressure transducer, and a concentration calculator and controller utilized to maintain the desired concentration by either increasing or decreasing the concentration of liquid desiccant in the basin by adding concentrated liquid desiccant or a fluid, or more desirably, adjusting the rate of regeneration to balance the system in such a way that the concentration of the liquid desiccant solution is maintained close to a setpoint or within a desirable range. Alternatively, the system may comprise a load cell to determine the weight/mass of the liquid desiccant rather than or with a pressure transducer.

In certain embodiments, the pressure sensor may be operationally coupled to the basin via a fluid conduit coupled to a sidewall or the bottom of the basin. Wherein the level sensor and/or concentration processor is configured to adjust the height of the liquid desiccant based on the operational coupling of the pressure sensor to the basin.

In some embodiments, a method for determining the concentration of liquid desiccant in a liquid desiccant air conditioning system is provided. The method includes placing a level tank in fluid communication with a basin of a liquid desiccant air conditioning system such that the height of the liquid desiccant in the level tank is the same height of the liquid desiccant in the basin and determining a height of the liquid desiccant in the level tank using a level senor in the level tank. The method also includes determining the mass of the liquid desiccant in the basin using a pressure sensor in fluid communication with the basin. The volume of the liquid desiccant is calculated using a known geometry of the basin and the height of the liquid desiccant in the level tank based on a signal from the level sensor and calculating a density of the liquid desiccant in the basin using the mass of the liquid desiccant based on the signal from the pressure sensor and the volume of the liquid desiccant such that the method may output a concentration of the liquid desiccant based on the calculated density. Alternatively, the mass of the liquid desiccant in the basin may be determined using a load cell.

In some aspects, the method includes controlling the concentration of the liquid desiccant between a high threshold and a low threshold by causing a fluid, such as water, to be automatically added to the basin to decrease the concentration of the liquid desiccant or causing concentrated liquid desiccant to be automatically added to the basin to increase the concentration, or by adjusting the rate of regeneration to balance the system in such a way that the concentration of the liquid desiccant solution is maintained close to a setpoint or within a desirable range.

These and other aspects of the present system and method will be apparent after consideration of the Detailed Description and Figures herein.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 shows a liquid desiccant air conditioning device consistent with the technology of the present application.

FIG. 2 shows a liquid desiccant air conditioning device consistent with the technology of the present application.

FIG. 2A shows a detail of a portion of the liquid desiccant air conditioning device consistent with the technology of the present application.

FIG. 3 shows a device on which the technology of the present application operates.

FIG. 4 shows an exemplary flowchart of a liquid desiccant concentration system consistent with the technology of the present application.

FIG. 5 shows a computer environment in which the technology of the present application operates.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to a liquid desiccant air conditioning system. However, the technology described herein may be used with applications other than those specifically described herein. For example, the technology of the present application may be applicable to other liquid desiccant de-humidifying systems, liquid desiccant regeneration systems, other evaporative systems or the like. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

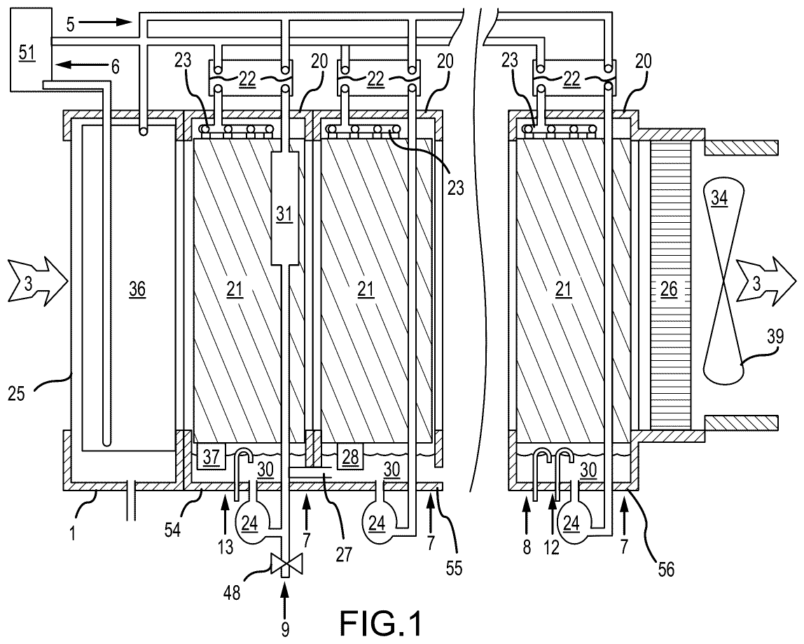

With reference now to FIG. 1, a liquid desiccant air conditioning system 1 (LDAC 1) is shown. The features of LDAC 1 are described in U.S. Pat. Nos. 9,982,901 and 10,923,436, which patents are incorporated by reference as if set out in full. For completeness, however, the LDAC 1 will be described herein in part for an understanding of the present technology. LDAC 1 receives an incoming air stream 3 to be cooled and de-humidified. The LDAC 1 comprises a modular structure having at least an initial module 54 and a terminal module 56. The initial module 54 and the terminal module 56 may be referred to as first module 54 and last module 56, first module 54 and second module 56, etc. However, the designation of first and/or second are to distinguish different modules and not necessarily related to a particular order. LDAC 1 optionally includes one or more intermediate module 55, which may be referred to herein as third module 55, fourth module 55, etc. The modules 54, 55, and 56 are essentially identical and interchangeable. The modules 54, 55, and 56 include an air enclosure 20 (or housing 20) containing a media pad 21, a desiccant distributor 23, and a basin 30 (although the basin 30 may be external to the housing 20 in certain embodiments).

Still with reference to FIG. 1, the LDAC 1 operates by moving air, via air stream 3, through the media pads 21 of the modules, such as modules 54 (initial module) and module 56 (terminal module), while liquid desiccant is dispersed by the desiccant distributor 23 through the media pad 21 to the basin 30. The liquid desiccant contacts the air and removes moisture from the air, i.e., de-humidifies the air, and cools the air in air stream 3. The air stream 3 is moved by an air movement device 34, such as a fan 34 as shown until the air stream 3 is exhausted out of an outlet 39. Alternatively, the air movement device 34 may be located at an intake 25 or inlet 25. The exhaust 39 or outlet 39 may, optionally, include one or more demisters 26 to remove water or other liquid in the air stream 3 at the exhaust. As can be appreciated, the desiccant is diluted by the absorption of moisture from the air stream.

The inlet 25 may, optionally, comprise a coil 36. As shown, the coil 36 is used to precondition the air stream 3 in advance of the air stream 3 entering the initial module 54. In this case, the coil 36 is used to cool (or heat) the air stream.

Generally, the liquid desiccant flows both cross and counter current to the air stream. The air stream enters the LDAC 1 with a relatively higher humidity and, as it travels through the modules in a generally left to right direction, as shown, is contacted by liquid desiccant to reduce the humidity until it exits the LDAC 1 at a relatively lower humidity. Simultaneously, the liquid desiccant flows, in each module through the media pads 21 from the desiccant distributor 23 to the sump 30 in a cross current (vertically from the top to the bottom as shown) and essentially orthogonal to the air stream 3, although other angulation is possible. Also, the liquid desiccant traverses from the terminal module 56 forward to the initial module 54 (generally right to left as shown), which is counter current to the air stream. As the liquid desiccant travels in a counter current, the liquid desiccant moves from a relatively higher concentration to a relatively lower concentration, as explained in U.S. Pat. Nos. 9,982,901 and 10,923,436, in other words, the desiccant is diluted as it absorbs moisture from the air stream. As shown in exemplary embodiments, the liquid desiccant may move from module 56 towards module 54 via a pump, such as pump 24, a tubular connection between basins 30, such as tube 27. Each basin 30 also may include level device 28, such as a float device or the like, to maintain the liquid desiccant level in each basin 30. As mentioned throughout the present application, the level device 28 at best approximates the level of desiccant in the basin 30 for a variety of reasons.

For completeness, as also shown in FIG. 1, each module (54, 55, 56) of LDAC 1 includes a heat exchanger 22, shown as external to the housing 20 although it could be contained in the housing 20 in certain embodiments. The heat exchanger 22 receives liquid desiccant from the basin 30 and cools (or heats) the liquid desiccant prior the liquid desiccant being distributed by desiccant distributor 23. The cooling (or heating in the alternative) of the liquid desiccant in heat exchanger 22 occurs when cooling fluid 5 (or heating fluid) exits an external exchanger 51 and is introduced to heat exchanger 22, where each heat exchanger 22 is in parallel such that the temperature of the cooling fluid 5 is substantially the same at the input to each of the heat exchangers 22, in other words, the temperature of the cooling fluid 5 arrives at each module 54, 55, 56 at essentially the same temperature. The cooling fluid leaves the external exchanger via fluid stream 5 enters the heat exchanger 22 and removes heat from the liquid desiccant prior to the liquid desiccant being discharged by the desiccant distributor 23. The cooling (or heating) fluid leaves the heat exchanger and returns the external exchanger 51 via fluid stream 6.

The cooling fluids are supplied in parallel to each heat exchanger 22 in each module and at essentially the same temperature to maximize the heat transfer out of the desiccant and thus from the treated air. This maximizes the enthalpy change in each sector and enables a lower source temperature to be used than if the cooling fluid is supplied in series to each heat exchanger. For a regenerative configuration, a similar argument applies to the effectiveness of using a common heating source for each sector in the desiccant regenerator.

As can be appreciated, the level sensors in the basins 30 (or singular basin 30) provides that fluid can be added to the system when the levels in the basins 30 indicate. For example, a low level might indicate an insufficient amount of solution to effectively cool and dehumidify, too high of a concentration of the desiccant solution, or a leak in the system. Likewise, a high level may indicate that the desiccant solution may have become too dilute or there may be a blockage or other means that is keeping the desiccant solution from being transferred to the regenerator. However, the level of the basin 30 is, at best, a proxy for the concentration of the liquid desiccant in the system. Also, the basin 30 generally is a turbulent environment with an unknown concentration of liquid desiccant and any given moment. The variables of this internal turbulent environment make determining the level of the basin 30 difficult and a difficult environment for electronic sensors, whether each module has its own basin 30 or whether a common basin 30 is provided.

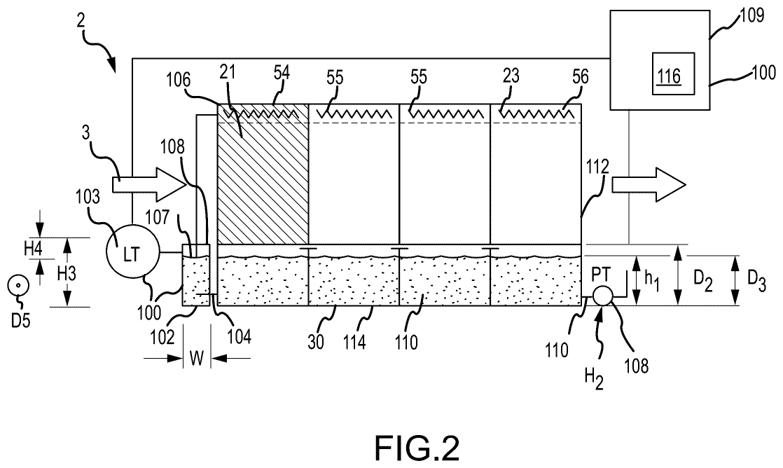

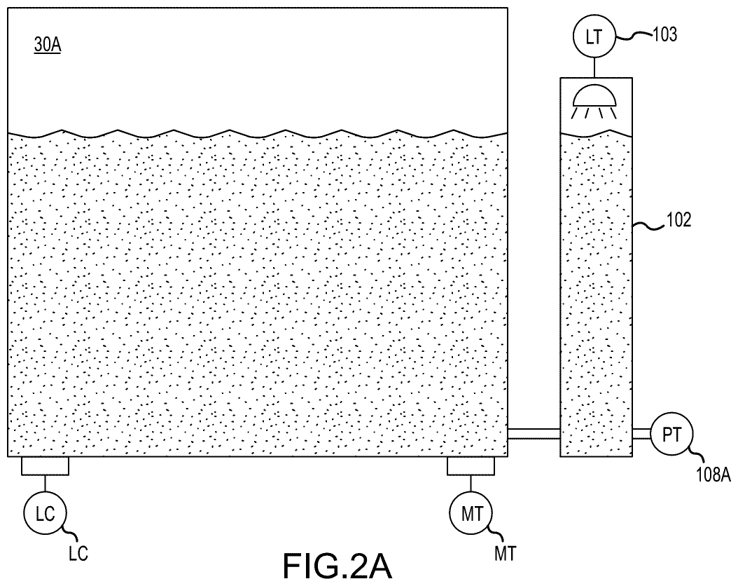

With reference to FIG. 2, a liquid desiccant air conditioning system (LDAC) 2 with a liquid desiccant concentration monitor system 100 is shown. LDAC 2 is substantially the same as LDAC 1 in many aspects including, for example, the modules 54, 55, and 56 along with the components included therein, such as, a media pad 21 and a desiccant distributor 23 for each module. The basins 30 also may have a desiccant pump coupled to the basin or basins or, in the alternative, the basins are otherwise in fluid communication to have a common liquid desiccant level. Except as required for an understanding of the present technology, these common components are not redescribed with reference to LDAC 2 for simplicity, clarity, and convenience.

FIG. 2 shows LDAC 2 with an initial module 54 and a terminal module 56 with two intermediate modules 55, although LDAC 2 can have no intermediate modules 55 or almost any number of intermediate modules 55. Each module includes a basin 30 as shown. As explained with respect to LDAC 1, the liquid desiccant may be pumped between the basins 30 or, in the alternative, the basins 30 may otherwise be in fluid communication to provide a common level of liquid desiccant in each basin 30. In other aspects, the basin 30 may be a common basin 30 or common return header. The constant flow of liquid desiccant from the media pad 21 to the basin 30 and within the basin or basins 30 causes the fluid movement that makes detecting a level of the liquid desiccant difficult and in any case in this turbulent environment highly variable and imprecise.

As shown in FIG. 2A, the liquid desiccant concentration monitor system 100 may include a level tank 102, with a level sensor 103, a pressure sensor 108, such as a pressure transducer PT, and a concentration processor 109. The level sensor 103 and pressure sensor 108 are operationally coupled to the concentration processor 109 to provide inputs to the concentration processor 109 as will be explained below. The coupling may be a wired or wireless connection. If a wireless connection, the connection can follow any number of wireless protocols, such as Bluetooth, near field radio communication, wireless fidelity (Wi-Fi) connections, or the like.

The level tank 102 is generally a small volume tank (although it may be designed to be approximate the size of the basin 30 or larger) that typically holds significantly less volume than basin 30 (either a common basin or individual basins). The level tank 102 has a known height H3, a known depth D5, and a known width W. The level tank 102 is in fluid communication with the basins 30 through the conduit 104 such that the height of the liquid desiccant is the same height of the liquid desiccant in the basins 30, but with reduced fluid flow and turbulence. The space above the liquid in the level tank 100 is operationally coupled to supply header 106 of liquid desiccant to desiccant distributor 23, which causes the level tank 100 to have the same head pressure to which the basins 30 are subjected, which is typically close to, but often slightly less than, atmospheric pressure in some instance. The level tank 102 includes a level sensor 103. The level sensor 103 in this exemplary embodiment is an ultrasonic level sensor 103 that senses the height of the liquid desiccant in the level tank 102, which height is h₁. Without going into specifics, the ultrasonic level sensor measures the distance from a top 105 of the level tank 102 to a top 107 of the liquid desiccant in the level tank 102, in this exemplary embodiment, such that the height h₁ is the height H3 less the distance from the top 108 of the level tank 102 to the top 107 of the liquid desiccant, which is designated H4. In other words, the h₁=H3-H4. The level sensor 103 may pre-process a signal to the concentration processor 109 such that the signal received by the concentration processor 109 is the height of the liquid desiccant h₁ or the concentration processor 109 can process the signals to obtain the height h₁. In part, the ultrasonic level sensor 103 is operational because the level tank 102 is in fluid communication with the LDAC 2 but in a level tank 102 that does not receive runoff from the media pad 21 or other turbulent flow.

The separate level tank 102 allows for reading the height of the liquid desiccant in the basin 30 as it removes many of the conditions, such as, for example, desiccant flow, that make level measurement directly in basins 30 difficult. Determining a sufficiently accurate height of the liquid desiccant in basins 30 is complicated by the fact that the liquid desiccant is continuous flowing in the LDAC 2, either via direct spray into an airstream to be treated, or flow thru a variety of packing arrangements or structured media designed to promote intimate contact between the highly hygroscopic desiccant solution and the moist air it is intended to condition. As a result, the internal conditions of such equipment do not lend themselves to accurate direct measurement of the liquid desiccant solutions themselves. Furthermore, internal conditions are ever-changing, turbulent, and always moving in the basins. Thus, the liquid levels in the basins are not static as they are continuously being splashed or rippled by down coming desiccant from the contact portion of the equipment.

As can be appreciated, the amount of liquid desiccant in the basins may drop over time as some liquid desiccant is taken from the system by the cross over to the air stream. Also, leakage and evaporation cause some decrease in the overall level of the liquid desiccant. The level of liquid desiccant is increased periodically by supplying liquid desiccant from a source.

A liquid desiccant LD enters the basins 30 from the media 21 of the various modules 54, 55, 55, and 56 of the LDAC 2. As can be appreciated, the liquid desiccant LD as it enters each basin 30 may be a different concentration. The concentration of the liquid desiccant is dependent on one or more variables including, for example, the humidity of the air stream. Higher humidity air streams typically dilute the concentration of the liquid desiccant more than lower humidity air streams.

The basins 30 (or the single basin 30) have some type of pressure sensor 108. While shown as a single pressure sensor 108, the liquid desiccant concentration monitor system 100 may have a plurality of pressure sensors 108. The plurality of pressure sensors 108 should detect a common pressure (within a tolerance) for each of the basins 30 as the basins 30 are in fluid communication to have a common level of liquid desiccant throughout the system, or a level essentially very close to the same value. The pressure sensor 108 as shown is a pressure transducer PT, but could be an alternative sensor type. The pressure transducer PT measures the head pressure of the liquid desiccant in basin 30 that is present above the location of the sensor element. The pressure transducer PT is typically in fluid communication with the liquid desiccant LD, such as, by a fluid port 110 located in a sidewall 112 of the basin 30. If located off a fluid port 110 on a sidewall 112, the PT measures the pressure from its location to the surface level of the liquid desiccant, which is identified as H1. Because the pressure transducer PT is coupled to the sidewall 112, it is located above a bottom 114 of the basin 30, which needs to be compensated for by the liquid desiccant concentration monitor system 100, as will be explained further below. In certain embodiments, the pressure transducer PT would be in fluid communication with the basin 30 via a fluid port (not specifically shown but similar to fluid port 110) coupled to the bottom 114 of the basin 30. In this case, the additional height H2 would be incorporated into the pressure transducer PT reading, such that the differential would not need to be addressed. Also, in certain embodiments, the pressure transducer PT could be coupled to the level tank 102 instead of the basin 30. The pressure transducer PT (or other pressure sensor 108) can pre-process the signal generated such that the signal sent to the concentration processor 109 is the weight/mass of the liquid desiccant in the basins or the concentration processor 109 can process the signal into the weight/mass of the liquid desiccant.

The liquid desiccant in basin 30 has its weight or mass determined by the pressure transducer PT. However, because the concentration/dilution, in other words, density, of the liquid desiccant in the basin 30 is unknown, and because the pressure transducer does not provide an accurate measure of the level of liquid desiccant in basin 30 and, hence, the total volume of liquid desiccant in basin 30 and the density or concentration of the liquid desiccant is generally unknowable in conventional liquid desiccant air conditioning systems, which deficiency is addressed by the separate level tank 102 and level sensor 103 of the liquid desiccant concentration monitor system 100.

FIG. 2 shows a pressure sensor 108 as a pressure transducer PT as one exemplary embodiment. FIG. 2A is a detail of a common basin 30A of liquid desiccant with alternative measurement devices to determine the mass. FIG. 2A, similar to the above, includes a separate level tank 102 and level sensor 103 to measure the height h₁. Level sensor 103 is shown in FIGS. 2 and 2A as an ultra sonic level sensor, but other types of level sensors 103 are usable with the present technology. For example, level sensor 103 may be an acoustic device, a sonar device, a float device, a reed switch, or the like. FIG. 2A shows a pressure transducer 108A directly off the level tank 102 rather than the basin 30A, which is described above but not shown in FIG. 2. FIG. 2A provides alternative weight/mass sensors. For example, in certain embodiments, the weight/mass may be determined using a mass transducer MT. In another example, in certain embodiments, the weight/mass may be determined using a load cell LC. Notice, while a single alternative sensor is shown, the PT, MT, and LC may use multiple sensors to determine the pressure, mass, and/or load for the basin 30A. As can be appreciated, the pressure sensor 108 should be construed broadly to include alternative sensors, of which three specific types are disclosed but others are not excluded, to determine the mass of the liquid desiccant in the basin. In certain aspects, the sensors may measure weight rather than mass.

Generally, the pressure/mass/weight sensors may be used to determine whether concentration is increasing or decreasing based on the change in pressure/mass/weight of the liquid desiccant and/or change in level. For example, if the level of the liquid desiccant remains constant, an increase in pressure/mass/weight generally is indicative of a higher concentration and a decrease in pressure/mass/weight generally is indicative of a lower concentration. As can now be appreciated, if the pressure/mass/weight of the liquid desiccant remains constant, a lower level generally is indicative of a higher concentration and a higher level generally is indicative of a lower concentration.

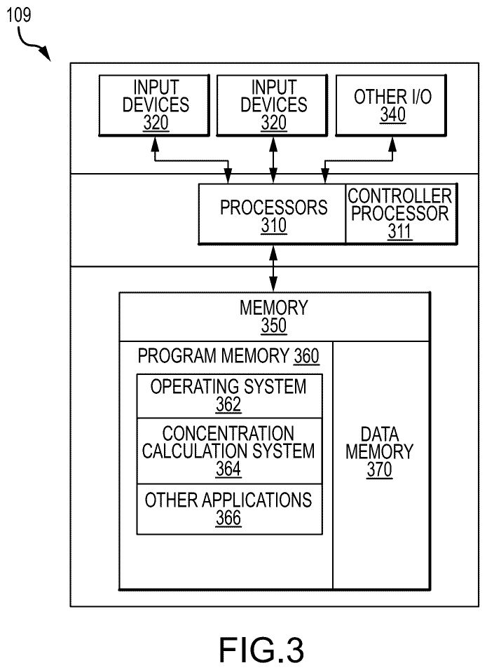

FIG. 3 shows an exemplary embodiment of the concentration processor 109. The concentration processor 109 described herein can automatically determine the concentration of the liquid desiccant in LDAC 2 using the input from the level sensor 103 and the pressure sensor 108. The methods and systems disclosed herein provide technical advantages over conventional liquid desiccant air condition systems because, among other things, the efficacy of the liquid desiccant air condition system is dependent, in part, on the concentration of the liquid desiccant in the system. The concentration of the liquid desiccant may be too low in certain instances and too high in others. As explained previously, the concentration of liquid desiccant, whether high or low, causes operational issues. For example, high concentrations of liquid desiccant may result in reduced liquid levels, which may be because of excess regeneration or fluid transfer within the system. In another example, low concentrations of liquid desiccant may result in ineffective drying of the air stream. Yet, conventional liquid desiccant system are not capable of determining the concentration of the liquid desiccant. Several implementations of the concentration processor 109 are possible. FIG. 3 is a block diagram illustrating an overview of a device (or devices) on which some implementations of the disclosed technology can operate. The concentration processor 109 can include one or more input devices 320 that provide input to a central processor unit (CPU) 310, which may be a single CPU or a plurality of CPUs, of the concentration processor 109. CPU 310 is generic and may include, among other things, CPU(s), GPU(s), HPU(s), combinations thereof, and the like. The input devices 320, such as are common with basic input/output systems (BIOS), maybe data ports that receive data from, among other things, the level sensor 103 and the pressure sensor 108. Other input devices may include, for example, a mouse, keyboard, touchscreen, or the like. The CPUs 310 and input devices 320 may be coupled by hardware devices such as, for example, a PCI bus, a SCSI bus, a combination thereof, and the like. The concentration processor 109 may further have one or more displays 330 and other input/output devices 340, such as, for example, audio (for alarms and warnings), printers, text messages, short message services, cellular communication, etc.

In some implementations, the concentration processor 109 also includes a communication device capable of communicating wirelessly or wire-based with a network node. The communication device can communicate with other devices or a server through a network using, for example, TCP/IP or BACnet protocols.

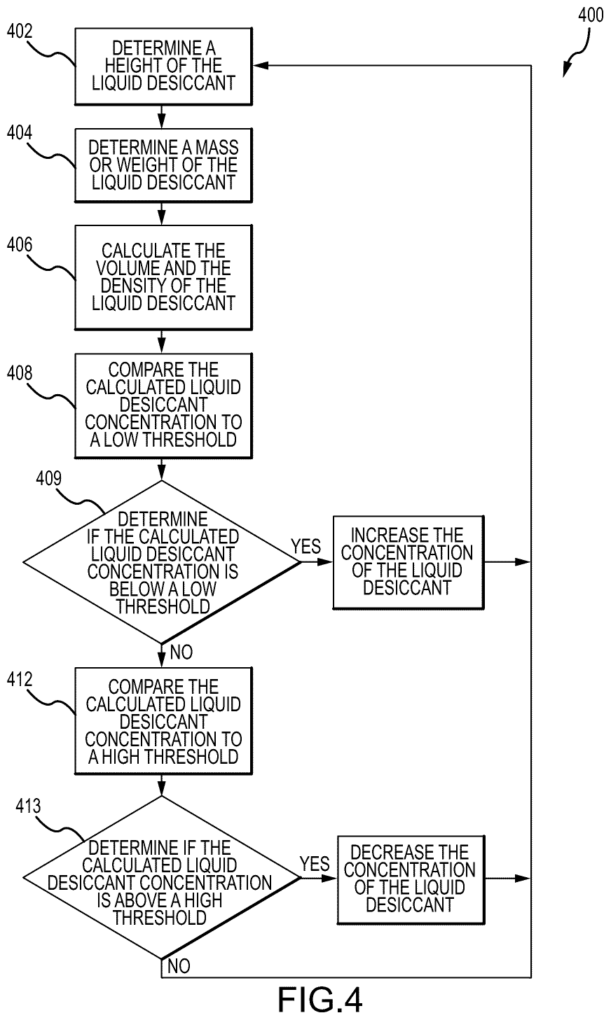

The CPU 310 includes a memory 350 in the concentration processor 109 or separate from but operatively connected to concentration processor 109. The memory 350 includes one or more hardware devices for volatile and non-volatile storage, and can include both read-only and writable memory. In some instances, the memory may be random access memory (RAM), caches, registers, read-only memory (ROM), flash memory, optical and magnetic memory, external drives, and the like. The memory 350 is not a propagating signal divorced from underlying hardware and is non-transitory. Memory 350 includes program memory 360 that stores programs and software, such as an operating system 362, concentration calculation system 364 (see FIG. 4), and other application programs or systems 366 that may be necessary for the concentration processor 109 to implement and preform the functions, operations, and programs described herein. The memory 350 includes data memory 370, such as the aforementioned dimensions, such as height, and pressure/mass/weight data, that may be necessary or useful for the concentration calculation system 364 to perform the operations described herein. As can be appreciated, the concentration processor 109 may be a device or apparatus specially designed to determine the concentration of the liquid desiccant or a general-purpose computer specially programmed consistent with the technology described herein to determine the concentration of the liquid desiccant.

FIG. 4 is a flowchart 400 showing an exemplary methodology that concentration processor 109 may use to determine a concentration of the liquid desiccant. Although the dilution of the liquid desiccant LD exiting the various modules will be likely be different as the liquid desiccant LD exits the media pads and flows to the basins 30 (or the common basin 30). Moreover, although flowchart 400 provides discrete steps in a set order, a person of skill in the art will recognize on reading the disclosure that the steps may be performed in alternative order, simultaneously, or the like. Each step described may further be broken into several additional steps not specifically described and/or certain described steps may be combined into a single operation. At step 402, the concentration processor 109 determines (obtains, measures, or calculates) a height of the liquid desiccant. The determination step 402 may comprise receiving a signal indicative of the height of the liquid desiccant in the level tank 102 form the level sensor 103 or, in the alternative, may comprise calculating the liquid desiccant height in the level tank 102 from the signal received from the level sensor 103. At step 404, the concentration processor 109 determines (obtains, measures, or calculates) the mass or weight of the liquid desiccant in the basin 30. The determination step 404 may comprise receiving a signal indicative of the mass or weight of the liquid desiccant in the basin 30 from the pressure sensor 108 (or pressure transducer PT in this exemplary embodiment) or, in the alternative, may comprise calculating the mass or weight of the liquid desiccant in basin 30 from the signal received from the pressure sensor 108.

Next, at step 406, with the height of the liquid desiccant now known, and the mass or weight of the liquid desiccant now known, the concentration processor 109 can calculate the volume and density of the liquid desiccant in the basin 30 (or basins 30). Specifically, the basins 30 as shown in FIGS. 1 and 2 are a rectangle, for simplicity, although they can have any geometric configuration. As a rectangle, the volume of liquid desiccant in the basins equals the known internal volume of the basins, collectively or individually, which equals D1 (total length of the basins 30)*D4 (total width of the basins 30), times the height of the column of liquid desiccant, which is h₁. Thus, the total volume is determined by the formula:

$$Liquid Desiccant Volume = D 1 * D 4 * {h}_{1}$$

In the exemplar embodiment depicted in FIG. 2, the mass of the liquid desiccant is a direct conversion from the pressure sensor 108 (or pressure transducer PT) in pounds. Thus, the density of the liquid desiccant is determined by the formula:

Liquid Desiccant Density=Mass/(Liquid Desiccant Volume)

The density of the liquid desiccant may be considered the calculated liquid desiccant concentration, which may be adjusted by liquid desiccant temperature to improve precision. In other words, the concentration processor 109 may adjust the concentration by comparison to a known table of desiccant densities adjusted by temperature. Of course, the above formulas assume the pressure sensor 108 measures the total mass of the liquid desiccant in the basin 30, which is often impractical. As described above, the pressure sensor is often fluidly coupled to the basin 30 from a location up the sidewall a distance H2 such that the pressure registered by the pressure sensor is the head pressure H1 of the liquid desiccant above the pressure sensor 108, where H1 equals h₁−H2). In this case, the above formulas for the volume may be modified such that the volume is determined by the formula:

$$Liquid Desiccant Volume = D 1 * D 4 * {h}_{1} or D 1 * D 4 * ( H 1 + H 2 )$$

In other words, the level sensor and/or the concentration processor adjust the height of the liquid desiccant based on a position of the pressure sensor. The concentration processor 109 may also include a liquid desiccant concentration controller 116 that may be a separate controller processor 311 or incorporated into processor 310, which may also be a separate controller although shown incorporated in the concentration processor 109 here. At step 408, the controller 116 would compare the calculated liquid desiccant concentration to range of values including a low threshold and a high threshold, or to a desired desiccant concentration setpoint. If it is determined, at step 409, that the liquid desiccant is below the low threshold (where below the low threshold could be equal to or below the low threshold in certain embodiments), the method moves to step 410 where the controller 116 causes an increase in the liquid desiccant concentration. Increasing the concentration of liquid desiccant may occur in a number of different ways. In one exemplary embodiment, the regeneration rate of the regenerating device is increased, such as by increasing the exchanger fluid media temperatures. Increasing the regeneration rate as compared to the de-humification rate tends to increase the overall concentration of liquid desiccant in the system. In another exemplary embodiment, the controller may cause a supply of a higher concentration liquid desiccant to be delivered to the basins 30 to increase the concentration. In some cases, the addition of concentrated liquid desiccant would be coupled with a low level detected in the level tank 102 or basin 30. Once the concentration step 410 is complete, control returns to step 402. If it is determined that the liquid desiccant is above the low threshold (where above includes equal to or above), the method moves to step 412. At step 412, the controller 116 would compare the calculated liquid desiccant concentration to a high threshold. If it is determined, at step 413, that the liquid desiccant is above the high threshold (where above includes above or equal to), the method moves to step 414 where the controller 116 causes a decrease in the liquid desiccant concentration. Decreasing the concentration of liquid desiccant may occur in a number different ways. In one exemplary embodiment, the regeneration rate of the regenerating device is decreased, such as by decreasing the exchanger fluid media temperatures. Decreasing the regeneration rate as compared to the de-humification rate tends to decrease the overall concentration of liquid desiccant in the system. In another exemplary embodiment, the controller may cause a fluid, such as water, from a supply to be delivered to the basins 30 to decrease the concentration, and control returns to step 402. In some cases, the addition of a fluid to dilute the concentration would be coupled with a low level detected in the level tank 102 or basin 30. Once the concentration adjustment step 414 or if no concentration adjustment is necessary because it is determined that the liquid desiccant is below the high threshold (where below includes equal to or below), the method move to step 402 and the process repeats. The control scheme, as described above, can be modified to control around a setpoint concentration rather than between high and low thresholds as a matter of design choice.

Now knowing the concentration of the liquid desiccant, in real time, it is possible to control the regeneration portion of the above described systems to optimize energy use. For example, knowing the concentration during cooler times of the year, in other words when the overall outside air temperature is lower and the outside air humidity is lower, it is possible the liquid desiccant does not need to be as concentrated as it does for hotter times of year. Thus, the load on the regeneration portion of the above systems can be lowered. Also, because the concentration is accurately known in real time, it is possible to concentrate the liquid desiccant above typical operating concentrations during non-peak energy hours, in other words, overnight for example. The liquid desiccant can be brought to a higher concentration without causing crystallization of the liquid desiccant. During the peak energy hours, as the air conditioning system is operating, the regeneration portion can operate at a lower energy usage as the concentrations decreases from the high concentration built up overnight, acting as an energy storage system in at least this facet. These are just two further benefits of knowing the actual concentration of the liquid desiccant.

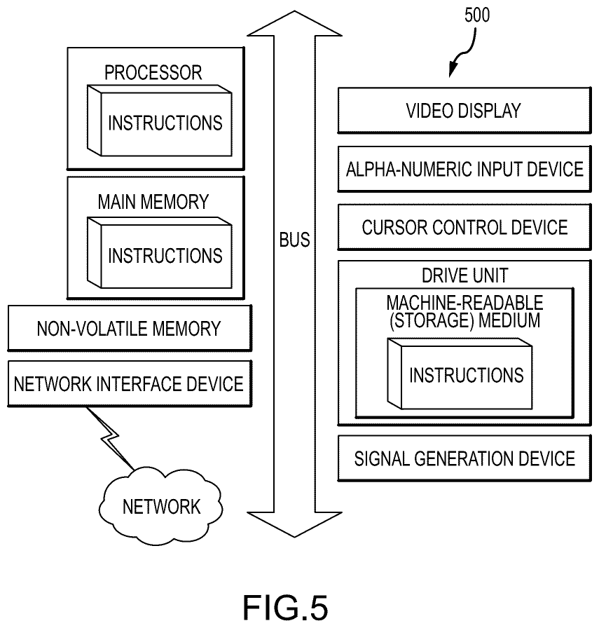

The technology described herein optionally comprises many networked machines. FIG. 5 depicts a diagrammatic representation of a machine, in the example form, of a computer system within which a set of instructions, for causing the machine to perform any one or more of the methodologies discussed herein, may be executed.

In the example of FIG. 5, the computer system 500 includes a processor, memory, non-volatile memory, and an interface device. Various common components (e.g., cache memory) are omitted for illustrative simplicity. The computer system 500 is intended to illustrate a hardware device on which any of the functions, applications, engines, and scripts are running as described herein and shown in figures (and any other components described in this specification) can be implemented. The computer system 500 can be of any applicable known or convenient type. The components of the computer system 500 can be coupled together via a bus or through some other known or convenient device.

The processor may be, for example, a conventional microprocessor such as an Intel microprocessor, Motorola microprocessor, or the like. One of skill in the relevant art will recognize that the terms “machine-readable (storage) medium” or “computer-readable (storage) medium” include any type of device that is accessible by the processor. The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 500. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted reside in the interface.

In operation, the computer system 500 can be controlled by operating system software that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually affect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are, at times, shown as being performed in a series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 96, other aspects may likewise be embodied as a means-plus-function claim, or in other forms, such as being embodied in a computer-readable medium. (Any claims intended to be treated under 35 U.S.C. § 112, 16 will begin with the words “means for”.) Accordingly, the applicant reserves the right to add additional claims after filing the application to pursue such additional claim forms for other aspects of the disclosure.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth)

What is claimed is:

1. A system for determining a liquid desiccant concentration in a liquid desiccant air conditioning system (LDAC) comprising,
a level tank having a top configured to be in fluid communication with a basin of the LDAC such that the level tank can contain liquid desiccant, wherein the level tank has a length, width, and height and the liquid desiccant contained in the level tank has a top;
a level sensor operationally coupled to the level tank to determine a height of the liquid desiccant contained in the level tank;
a pressure sensor operationally coupled to the basin of the LDAC to determine a mass of the liquid desiccant contained in the basin, wherein the basin has a known geometry;
a concentration processor operationally coupled to the level sensor and the pressure sensor wherein the concentration processor calculates a concentration of the liquid desiccant in the basin based on the height of the liquid desiccant and the mass of the liquid desiccant, and optionally corrects for desiccant temperature, wherein the concentration processor outputs the concentration of the liquid desiccant in the basin.

2. The system of claim 1, wherein the level sensor is an ultra-sonic level sensor.

3. The system of claim 1 wherein the pressure sensor is a pressure transducer.

4. The system of claim 1 comprising a temperature sensor operationally coupled to the basin of the LDAC to determine the temperature of the liquid desiccant solution contained in the basin, and wherein the temperature sensor is selected from a group of temperature sensors consisting of: a thermocouple, a thermistor, a resistance temperature detector, or a combination thereof.

5. The system of claim 1 comprising a liquid desiccant concentration controller operationally coupled to the concentration processor.

6. The system of claim 5 wherein the liquid desiccant concentration controller controls the concentration of the liquid desiccant by adding concentrated liquid desiccant to increase the concentration and by adding a fluid to decrease the concentration.

7. The system of claim 5 wherein the liquid desiccant concentration controller controls the concentration of the liquid desiccant by adjusting a relative rate of regeneration with respect to dehumidification.

8. The system of claim 5 wherein the liquid desiccant concentration controller also controls the concentration of the liquid desiccant based on input from the temperature sensor.

9. The system of claim 1 wherein the pressure sensor is coupled to a sidewall of the basin and the concentration processor adjusts the volume of the basin by a height of the pressure sensor above the bottom of the basin.

10. The system of claim 1 wherein the pressure sensor is coupled to a bottom of the basin.

11. The system of claim 1 wherein the pressure sensor is in fluid communication with the basin via a conduit coupled to the level tank.

12. The system of claim 1 wherein the pressure sensor is selected from group of sensors consisting of: a mass transducer, a load cell, or a combination thereof.

13. The system of claim 1 wherein the level sensor is selected from a group of sensors consisting of: a sonic sensor, a sonar sensor, a float sensor, a reed switch, or a combination thereof.

14. A method for determining the concentration of a liquid desiccant in a liquid desiccant air conditioning system, comprising:
placing a level tank in fluid communication with a basin of a liquid desiccant air conditioning system such that the height of the liquid desiccant in the level tank is the same height of the liquid desiccant in the basin;
determining a height of the liquid desiccant in the level tank using a level senor in the level tank;
determining a mass of the liquid desiccant in the basin using a pressure sensor in fluid communication with the basin;
calculating the volume of the liquid desiccant in the basin using a known geometry of the basin and the height of the liquid desiccant in the level tank based on a signal from the level sensor;
calculating a density of the liquid desiccant in the basin using the mass of the liquid desiccant based on the signal from the pressure sensor and the volume of the liquid desiccant; and
outputting a concentration of the liquid desiccant based on the calculated density.

15. The method of claim 14 wherein the step of calculating the volume comprises adjusting the height of the liquid desiccant based on a position of the pressure sensor.

16. The methods of claim 14 comprising comparing the concentration of the liquid desiccant to a low threshold and increasing the concentration if the concentration is below a low threshold.

17. The method of claim 16 wherein increasing the concentration of the liquid desiccant comprises adding concentrated liquid desiccant to the basin.

18. The method of claim 14 comprising comparing the concentration of the liquid desiccant to a high threshold and decreasing the concentration if the concentration is above a high threshold.

19. The method of claim 18 wherein decreasing the concentration comprises adding fluid to the basin.

20. The method of claim 14 comprising comparing the concentration of the liquid desiccant to a setpoint concentration and adjusting the concentration of the liquid desiccant to maintain the concentration at the setpoint.
